(19) United States
(12) Patent Application Publication
(10) Pub. No.: US 2017/0140397 A1
(43) Pub. Date: May 18, 2017

(54) MEASURING INFLUENCE PROPAGATION WITHIN NETWORKS

(71) Applicant: Estia, Inc., Brooklyn, NY (US)

(72) Inventors: Austin Avery Booker, San Antonio, TX (US); Andrew Franklin Whiddett, Santa Clarita, CA (US); Nakul Jeirath, San Antonio, TX (US); Estefan Miguel Ortiz, San Antonio, TX (US)

(21) Appl. No.: 15/355,294

(22) Filed: Nov. 18, 2016

Related U.S. Application Data
(60) Provisional application No. 62/256,802, filed on Nov. 18, 2015.

(51) Int. Cl. G06Q 30/02; G06Q 50/00

(52) U.S. Cl. CPC G06Q 30/0201; G06Q 50/01

(57) ABSTRACT

Techniques are described for measuring and ranking the influence of users in a network such as a social network. Influence metric(s) may be calculated that indicate the influence of publishing user(s) in a network based on calculating a number of users who are exposed to published and republished item(s) at one or more levels, or ripples, as the item(s) propagate in the network through republication. Publishing users may be ranked according to their degree of influence in general, or their degree of influence with respect to one or more particular categories of subject matter for the published item(s). Categories may include hierarchically related categories, sub-categories, and so forth, of varying specificity.

### CROSS-REFERENCE TO RELATED APPLICATION

The present disclosure is related to, and claims priority to, U.S. Provisional Patent Application Ser. No. 62/256,802, titled “Measuring Influence Propagation Within Networks,” which was filed on Nov. 18, 2015, the entirety of which is hereby incorporated by reference into the present disclosure.

### BACKGROUND

Traditionally, online marketing or advertising efforts have employed a generally unfocused approach in which information is indiscriminately targeted at a large population of online users. Such efforts may fail to effectively spread the word about a product or brand or fail to reach new audiences, leading to a diminished return on investment in marketing or advertising campaigns. Moreover, the growth of social media and the development of new means for content distribution have created new channels for communication and influence.

### SUMMARY

Implementations of the present disclosure are generally directed to measuring and ranking the influence of users in a network. More particularly, implementations of the present disclosure are directed to determining influence metrics that indicate the influence of user(s) in a social network in general, or with respect to one or more particular categories, based on calculating a number of users who are exposed to published item(s) at one or more levels, or ripples, of propagation of the item(s) in the social network.

In general, implementations of innovative aspects of the subject matter described in this specification can be embodied in methods that include actions of: determining a category of at least one item published by a publishing user on a network; determining a first propagation metric based on a number of followers of the publishing user on the network; identifying one or more republications of the at least one item by one or more republishing users on the network; determining a second propagation metric based on a number of followers of each of the one or more republishing users on the network; determining an influence metric indicating a level of influence of the publishing user in the category, the influence metric based at least partly on the first propagation metric and the second propagation metric; and providing a ranked list of the publishing user relative to other users who publish items associated with the category, the ranked list ordered based on the influence metric.

These and other implementations can each optionally include one or more of the following innovative aspects: at least one of the one or more republishing users is a follower of the publishing user; at least one of the one or more republishing users is a follower of a republishing user; the republishing user is a follower of the publishing user; determining one or more demographic characteristics of the followers of the publishing user and the followers of the one or more republishing users; the ranked list ranks the publishing user relative to other users for followers associated with the one or more demographic characteristics; determining the category of the at least one item further comprises calculating a similarity between terms in the at least one item and a list of terms corresponding to the category; determining the category of the at least one item further comprises associating the item with the category based on the similarity exceeding a threshold level of similarity; determining the second propagation metric further comprises iteratively counting the number of followers of each republishing user in multiple ripple levels as the at least one item propagates via republication in the network; the counting terminates after counting the number of followers in a ripple level that does not include a republishing user; the network is a social network; the at least one item is published or republished as one or more of a tweet, a post, a share, or a comment; the category is included in a hierarchy of categories with different degrees of specificity; determining a location of the followers of the publishing user or the followers of the one or more republishing users; the influence metric further indicates the level of influence of the publishing user in the category toward users in the location; the influence metric is further based at least partly on at least one of a number or a proportion of bidirectional connections of the publishing user; the influence metric is further based at least partly on a proportion of the number of followers of the publish user to a number of users followed by the publishing user; and/or the influence metric is further based at least partly on a change, over time, of a centrality metric for the publishing user.

Other implementations of any of the aspects include corresponding systems, apparatus, and computer programs that are configured to perform the actions of the methods, encoded on computer storage devices.

These and other implementations can provide one or more of the following technical advantages and/or improvements over currently used techniques. Implementation determine an influence metric for a user who publishes items through a network, such as a social network, by tracing the propagation of items across one or more levels of republication in the network. By determining influence based on the measured propagation of an item in a network, implementations provide an objective measure of user influence and thus provide a technological improvement compared to traditional platforms that, if they measure influence at all, may employ a more subjective means for determining influence. Employing predictive analytic technology, implementations track expected rising or falling levels of influence across individuals or among categories. Implementations also build and dynamically self-edit influencer database(s) to take into account updated information, unlike traditional platforms that rely on static databases which may be updated infrequently or not at all. Moreover, by employing an objective measure of user influence on network(s) and by dynamically updating influencer information, implementations provide a technological improvement compared to traditional computing systems which may employ subjective and/or static techniques for determining influence. Such subjective and/or static techniques for determining influence may be more susceptible to errors in measuring influence than the dynamically updated influence determination described herein. Thus, traditional computing systems may consume more processing power, data storage, active memory, network capacity, and/or other computing resources to recover from errors resulting from subjective influence determination based on static, possible out-of-date information, compared to systems that operate according to the implementations described herein. Moreover, systems that employ traditional static techniques for determining influence may require repeated, frequent executions to provide current, up-to-date measurements of influence, thus leading to a greater consumption of computing resources compared to systems that dynamically update influencer information according to the implementations described herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF DRAWINGS

FIG. 1 depicts an example environment for measuring influence propagation within a network, according to implementations of the present disclosure.

FIG. 2 depicts a flow diagram of an example process for measuring influence propagation within a network, according to implementations of the present disclosure.

FIG. 3 depicts a flow diagram of an example process for determining one or more categories associated with a published item, according to implementations of the present disclosure.

FIG. 4 depicts a flow diagram of an example process for determining an influence metric for a publishing user based on a number of potential viewers of a published item, according to implementations of the present disclosure.

FIG. 5 depicts a schematic of an example of influencer rankings based on influence metric(s), according to implementations of the present disclosure.

FIG. 6 depicts an example computing system, according to implementations of the present disclosure.

### DETAILED DESCRIPTION

Implementations of the present disclosure are directed to systems, devices, methods, and computer-readable media for measuring the influence of publishing users on networks, such as social networks, based on the number of possible viewers exposed to item(s) published by the publishing users. Implementations provide a data engine and platform that discovers and identifies online users who are influential and who may therefore be useful to help market a product, raise brand awareness, or otherwise spread ideas over network(s). The platform may identify those influencers who have a large (e.g., significant or outsized) “ripple effect,” such that when the influencer publishes (e.g., posts, tweets, etc.) online about a particular product, brand, keyword, or idea, other users who follow the influencer are likely to republish (e.g., share, repost, retweet, etc.) the originally published item. In this way, an influencer may influence followers, followers of followers, followers of followers of followers, and so forth out to N degrees of separation (e.g., ripples) from the original influencer. A user whose published items are frequently republished may have more influence than another user who posts about a brand but who is not reposted or shared by others. In some examples, a particular user may have more influence regarding one category compared to another category, or compared to a category for which the user is not yet known to be influential. For example, a user may post about cars and have that post reposted or shared by many other users, but the same user may post about fashion and have no one repost or share. In such examples, the user may be determined to be influential in the category of cars, but not influential in the category of fashion. The platform may identify particular categories corresponding to types of information, topics, or product areas where influencers have any degree of influence.

The platform may identify and rank influencers based on the number of potential viewers (e.g., “eyeballs”) reached by the influencers' published data items associated with various categories, as described further below. The platform determines the reach of a particular influencer by following the propagation, through subsequent sharing, retweeting, commenting, reposting, or other communications, of the influencer's published data items on a network as far as the items propagate (e.g., up to and potentially exceeding 100 million viewers). By analyzing the propagation of published data items within a network, the platform provides a solution for measuring and ranking network-based influence that is fundamentally rooted in technology for tracking the propagation of information on a network. For example, the platform collects and analyzes a large number (e.g., millions or billions) of published data items created by a large population of users, tracks the network communication and re-communication of the data items among the large population of users connected over a network, determines any number of categories or sub-categories associated with the data items, and analyzes all this information to automatically determine influence metrics and influence rankings that indicate the level of influence of publishing users with respect to one or more categories or sub-categories.

In some implementations, the platform accesses an initial list of influencers stored in database, and the platform may add to this initial list using the analysis described below. The initial list of influencers may include users who are known to be influential on various online channels (e.g., social networks), influential in particular categories for market segments (e.g., cars, jewelry, clothing, electronics, music, etc.), and/or influential with respect to particular demographic groups (e.g., age groups, geographic regions, etc.). In some examples, this initial list of influencers is manually or automatically determined based on characteristics like fan count, follower count, follower age, income, or location, or other considerations. The list of influencers may also include users who various companies have already worked with to spread information regarding the companies' brands, products, and/or services. The platform may analyze the degree of influence exerted by the various influencers in the list, rank them against one another, and quantify the particular extent of their influence regarding particular categories (e.g., types of products), demographic segments, and so forth. In some instances, the platform may analyze the degree of influence exerted by the various influencers in the list based on attributes that are found, derived, or otherwise determined with respect to one or more networks.

The platform may determine the degree of influence of a user with respect to one or more particular categories. A category may be a brand category, a type of product, a topic of information, and so forth. Categories may be arranged into a multi-level hierarchy with different levels of specificity. For example, a category of the brand Porsche™ may be a subcategory (e.g., more specific subcategory) of the category sports cars, which itself may be a subcategory of cars, which may be a subcategory of vehicles, which may be a subcategory of consumer goods, and so forth. A particular category may have any number of parent categories (e.g., less specific categories) as well as any number of child categories (e.g., more specific categories).

In some implementations, the degree of influence of a user may be based at least partly on a number or proportion of bidirectional connections between users. A bidirectional connection exists between two users who each follow the other, e.g., user A follows user B and user B also follows user A. The degree of influence of a particular user may be determined to be greater, compared to the influence exerted by other users, if the particular user has a greater number and/or greater proportion of bidirectional connections compared to the other users. For example, if user A has 100 followers and 80 of those are bidirectional connections, user A may be determined to have a higher degree of influence than user B who has 100 followers where 10 of those are bidirectional connections.

In some implementations, the degree of influence of a particular user may be based at least partly on the proportion between the number of followers of the particular user and the number of other users followed by the particular user. For example, user A may have 1000 followers and may follow 500 other users, such that the ratio of followers to followed is 1000/500, or 2/1. User B may have 200 followers and may follow 10 other users, such that the ratio of followers to followed is 200/10, or 20/1. In such examples, a determination may be made that user B has a higher degree of influence than user A given user B's higher ratio of followers to followed, even though user A has fewer followers than user B.

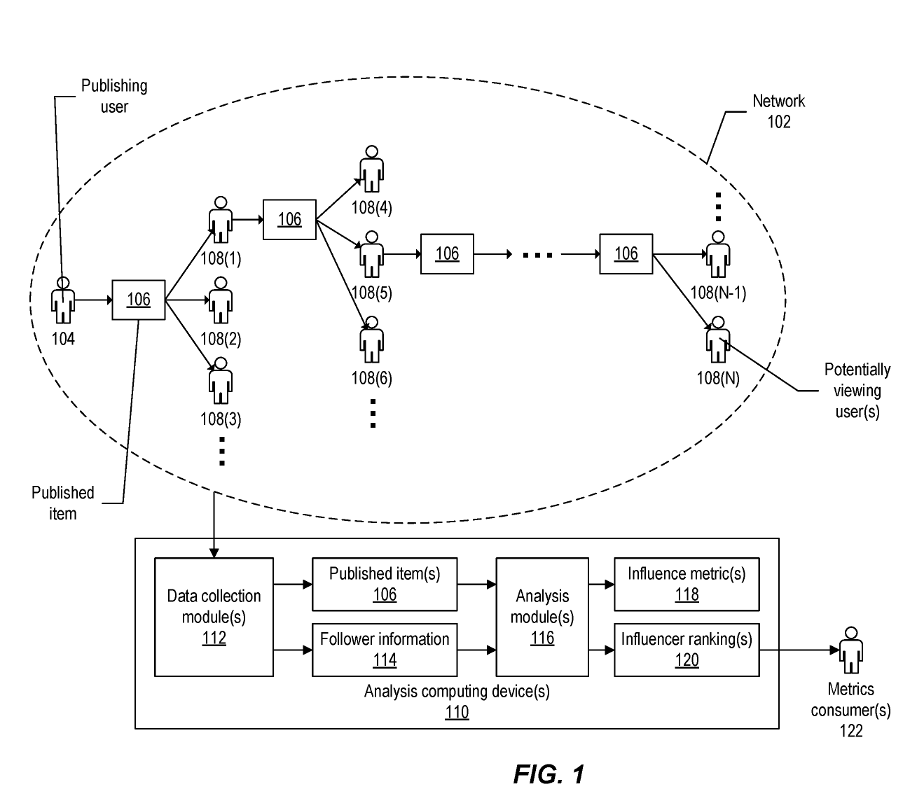

FIG. 1 depicts an example environment for measuring influence propagation within a network, according to implementations of the present disclosure. As shown in the example of FIG. 1, the environment may include one or more networks 102. A network 102 may include any type of network in which user(s) may publish item(s) to be viewed by other user(s), and the published item(s) may be republished by user(s). Accordingly, a network 102 may be a social network in which users communicate with other users via published items. A network 102 may include users who have registered with the network 102, such that the users have accounts, profiles, or other forms of presence in the network 102. Examples of a network 102 may include Facebook™, Twitter™, Instagram™, Pinterest™, Weibo™, WeChat™, Alibaba™, or others. A network 102 may be public, such that any user may be allowed to publish, view, and republish items. A network 102 may be, to some extent, private, such that a subset of the general public is allowed to publish, view, and republish items.

In the example of FIG. 1, a publishing user 104 has published an item 106 that may be viewable and/or republishable by other users 108 in the network 102. A network 102 may employ any data format or arrangement of data for published items 106, and published items 106 may be communicated within the network 102 using any communication protocol. A published item may include one or more types of data, including but not limited to text data, graphics, images, videos, audio data, and so forth. The publishing user 104 may be associated with a set of followers 108(1), 108(2), 108(3), and so forth in the network 102. A follower of a publishing user 104 may include a user 108 who has indicated a desired to view published item(s) 106 of the publishing user 104. For example, a follower may edit their user profile or account information to follow the publishing user 104, and subsequently the follower may receive notifications indicating when the publishing user 104 publishes an item 106. A follower may be variously described in different social networks as a follower, a friend, a contact, a link, a fan, and so forth.

In the example of FIG. 1, one of the followers of the publishing user 104 (e.g., the user 108(1)), has republished the original published item 106 of the publishing user 104. Republication may include, but is not limited to, sharing, reposting, retweeting, or commenting on the published item 106, such that the published item 106 may then be viewed by other users 108. Republication may include republication of the published item 106 in its entirety, or republication of any portion of the published item 106 (e.g., as an excerpt). The user 108(1), and/or other followers of the publishing user 104, may republish the item 106 such that the item 106 is viewable by a second group of users 108(4), 108(5), 108(6), and so forth who are followers of the user 108(1) or other user(s) who republished the original published item 106. Any number of those followers may then republish the item 106 to be viewable by a third set of followers, who may themselves republish the item 106 to be viewable by a fourth set of followers, and so on to any number of republication levels.

Each set of republications by one or more republishing users 108 may be described as a ripple of the published item 106 as it propagates within the network 102. For example, the original publication of the item 106 by the publishing user 104 may be viewable by a first set of followers 108 in a first ripple, one or more of the first set of followers 108 may republish the item 106 to be viewable by a second set of followers 108 in a second ripple, one or more of the second set of followers 108 may republish the item 106 to be viewable by a third set of followers 108 in a third ripple, and so on. The published item 106 may, in this manner, propagate in the network 102 across any number of ripples until it reaches a ripple where the item 106 is viewable by one or more followers 108 but not republished by any of them. This final ripple is illustrated in FIG. 1 as the users 108(N-1), 108(N), and so forth. Each ripple may include any number of users 108 who may view and/or republish the item 106.

Although examples herein may describe users viewing an item that is published in a network 102, implementations are not limited to item(s) 106 that are visually presented to users. An item 106 may also be presented, at least in part, as audio data, haptic data (e.g., vibrations or other movements of a computing device), or via other methods.

As shown in the example of FIG. 1, the environment may include one or more analysis computing devices 110, which may include any number of any type of computing device. The analysis computing device(s) 110 may be described as a platform for measuring influence in the network(s) 102. The analysis computing device(s) 110 may execute any number of software module(s), which may be described as an engine for measuring influence.

The analysis computing device(s) 110 may execute one or more data collection module(s) 112 which collect information regarding one or more network(s) 102. The data collection module(s) 112 may retrieve and store one or more published item(s) 106 published on the network(s) 102. The published item(s) 106 may include metadata describing the published item(s) 106, including but not limited to a timestamp (e.g., date and/or time) of publication, the publishing user 104, a subject line, title, or summary of the item 106 as published, or other metadata such as tags, hashtags, and so forth. The data collection module 112 may also retrieve and store follower information 114 that describes, for each of one or more users, the set of followers of the user. The data collection module 112 may also retrieve and store other information available in the network(s) 102, such as demographic information regarding the users of the network(s) 102. Demographic information may include various user characteristics, including but is not limited to one or more of the following: user location (e.g., to any degree of specificity), age, gender, ethnic identification, spoken language(s), profession, hobbies, interests, income level, purchase history, group affiliation(s), education level, or other characteristics.

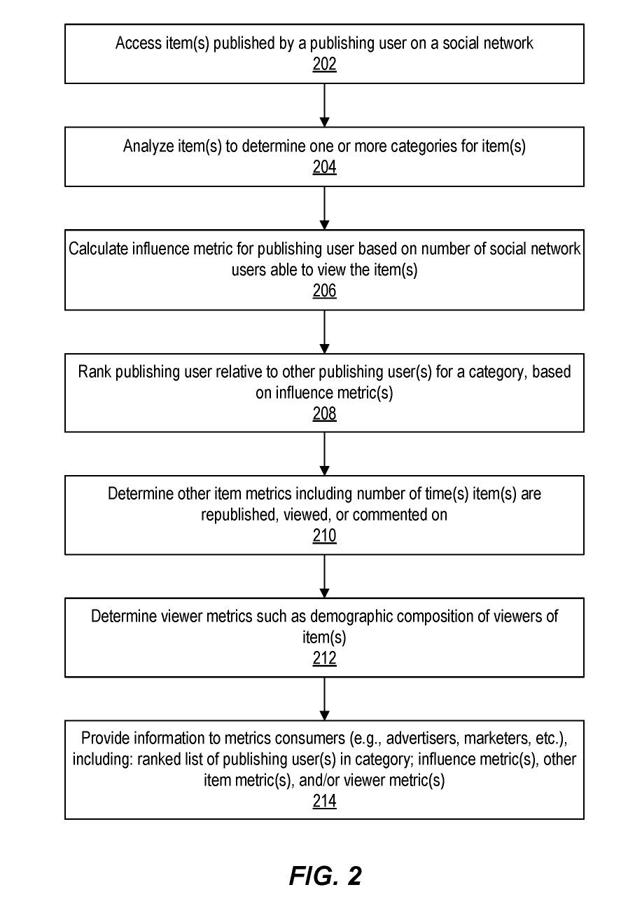

The published item(s) 106, follower information 114, or other data regarding the network(s) 102 may be accessed and analyzed by one or more analysis modules 116 executing on the analysis computing device(s) 110. Operations of the analysis module(s) 116 are described further with reference to FIGS. 2-4. In some implementations, the analysis module(s) 116 may generate one or more influence metric(s) 118. An influence metric 118 may indicate, for a particular publishing user 104, a degree of influence exerted by the publishing user 104 in the network(s) 102. In some implementations, the influence metric 118 of a publishing user 104 corresponds to a number of users 108 (e.g., N in FIG. 1) who view, or are able to view, the published item(s) 106 of the publishing user 104, such as the number of followers of the publishing user 104, the number of followers of republishing followers, the number of followers of republishing followers of republishing followers, and so forth. In some implementations, the analysis module(s) 116 may generate influencer ranking(s) 120 that ranking various publishing users 104 relative to one another. The influencer ranking(s) 120 may provide a ranked list of publishing users 104 that is ordered according to the influence metric(s) 118 of the publishing users 104. Such rankings may be with respect to one or more particular categories, or may indicate influence generally without respect to a particular category.

The influence metric(s) 118, influencer ranking(s) 120, and/or other information may be stored and communicated to one or more metrics consumers 122. The metrics consumer(s) 122 may include advertising or marketing professional, or others with an interest in influence propagation in the network(s) 102. In some examples, metrics consumer(s) 122 may employ the influence metric(s) 118 and/or the influencer ranking(s) 120 to identify one or more publishing users 104 who are influential within the network(s) 102 in general, or with respect to particular categories. Such publishing user(s) 104 may then be employed (e.g., by the metrics consumer(s) 122) to spread information regarding brands, products, services, campaigns, or other information. By identifying publishing user(s) 104 who are most influential within network(s) 102 with respect to particular categories, implementations enable marketers, advertisers, or others to create category-specific campaigns that are more effective at spreading information than traditional campaigns which may indiscriminately broadcast information within a network 102, leading to potential higher return on investment for marketing or advertising expenditures.

In some implementations, the determination of the influence metric(s) 118 and/or influencer ranking(s) 120 may be performed dynamically with respect to the generation and/or collection of the network information such as the published item(s) 106 and/or the follower information 114. A dynamic process may be described as a process that is performed in real time with respect to a triggering event, such as the execution of another process, the presence of data, and/or detection of a particular state of a system. The process may be performed without intentional delay following the triggering event, taking into account any latencies incurred in communicating the data over network(s) and performing operations on computing system(s). In some implementations, there may be no intentional delay between collection and/or generation of the network data and the analysis of the network data to generate the influence metric(s) 118 and/or influencer ranking(s) 120. In some instances, a dynamic process may be performed within a same execution sequence, block, and/or thread as the triggering event, or the dynamic process may be launched or triggered through a process call and/or message that is sent within the same execution sequence, block, and/or thread as the triggering event.

In some implementations, the influence metrics may be further determined based on a network topology for one or more users. This may include tracking a user's measure of centrality over time and determining the rate of growth (or decline) of their centrality. This rate of change, and direction of the change, of the centrality measure may indicates if a given user is increasing or decreasing in influence over time, and may be employed to determine the influence metrics instead of or in addition to the other algorithms described herein. The rate and/or direction of the change may also be used to determine the ranked recommendations. For example, a user with an increasing change in centrality may be ranked higher than other users in a list of recommended potential influencers for a particular category.

A measure of centrality for a given user, e.g., node, in a network gives an indication of the user's measure of influence, dependent on the particular centrality measure that is applied. For example, a simple degree centrality algorithm measures the number of connected links for a given user, e.g., the number of other users directly connected to the user. As another example, a cross-clique centrality algorithm provides a measure of how well a user is connected to groups of other users, e.g., groups of other nodes. Node centrality may be viewed as a single snapshot in time, or as a stochastic process.

Some implementations model a given user's, or node's, centrality measure over time, and the model may be used to predict when the user will become more influential or when their influence will begin to wane. This model may be applied to a node that is a user, and/or to other types of nodes in the network such as a product, category, and/or a group of nodes that correspond to an idea or concept where the system may have established a network topology. Time series modes may be applied, such as autoregressive integrated moving average models (ARIMA), and/or more advanced non-linear and adaptive filter techniques, to capture the time series structure and make forecasts regarding influence as measured through an (e.g., arbitrary) centrality metric time series.

In some implementations, to make predictions regarding influence, centrality may be modeled as a time series, e.g., c(t)=[c(1), c(2), . . . . c(N)]. Time series methods such as adaptive filter methods and/or other algorithms may then be applied to the time series. For modeling and prediction, the system may effectively estimate the conditional expectation E[c(t)|{c(t-1)}] for a time series with function(s) that have a determined structure F({c(t)}). Thus, a prediction can be seen as a shift in time for the conditional expectation E[c(t+1)|{c(t)}]. For example, with an autoregressive (AR) model the assumed structure is a weighted tapped delay on the input series: c(t)_estimate=E[F{c(t)}], where F{c(t)} may be determined according to Example Formula 1 below:

F{c(t)}=a0+a1*c(t-1)+a2*c(t-2)+. . . aj*c(t-j)+error_term Example Formula 1

Thus, in some instances a prediction would be a shift in F{c(t)} to F{c(t+1)}. The coefficients in Formula 1 may be estimated using the sample series and may remain fixed for future incoming data. In implementations that employ an adaptive approach, the coefficients may be updated as new observations are received. Thus, the centrality time series may provide estimate of influence over time such that predictions indicate predicted future influence for a given user/content.

Implementations may employ any suitable centrality metric, which may also be described as a centrality measure or algorithm. Some implementations may employ a fusion approach based on multiple centrality measures, such as determining a weighted average, Bayesian fusion, and/or some other combination of the results of multiple centrality metrics. Some implementations may employ measure of centrality and track its behavior over time to develop a process that makes use of time series modeling approaches.

FIG. 2 depicts a flow diagram of an example process for measuring influence propagation within a network, according to implementations of the present disclosure. Operations of the process may be performed by one or more of the data collection module(s) 112, the analysis module(s) 116, or other software module(s) executing on the analysis computing device(s) 110 or elsewhere.

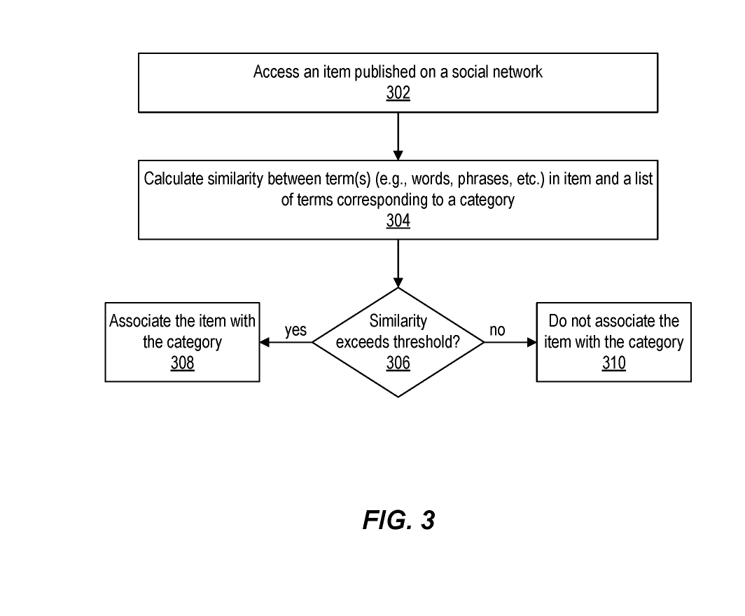

In some implementations, the published item(s) 106 of a particular publishing user 104 may be analyzed to determine influence metric(s) 118 that each indicate a degree or amount of influence of the publishing user 104 with respect to a particular category, or in general. The published item(s) 106 of a publishing user 104 on a network 102 may be accessed (202). The published item(s) 106 may be analyzed (204) to determine one or more categories for each item 106. Determination of categories is described further with reference to FIG. 3.

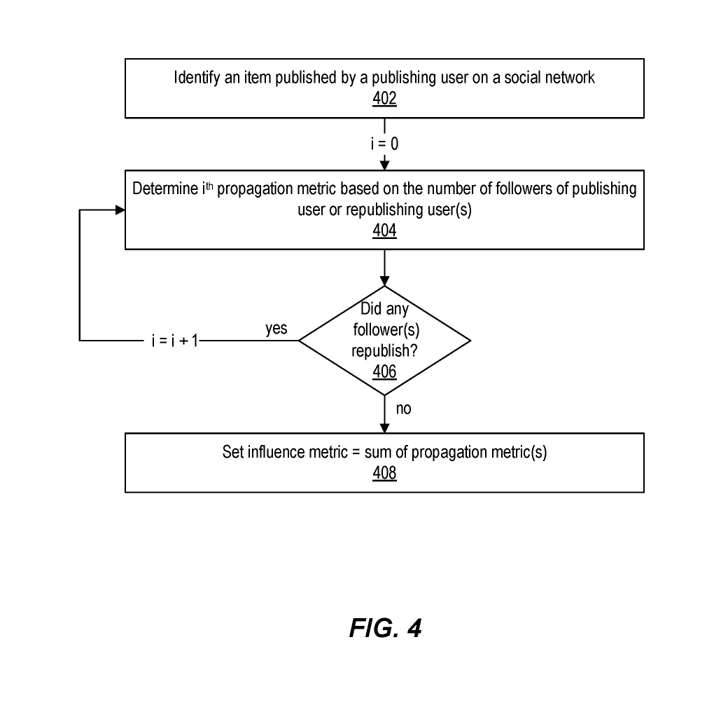

An influence metric 118 may be calculated (206) for a publishing user 104, the influence metric 118 based on a number of users 108 who are exposed to the published item(s) 106 of the publishing user 104 on the network 102. Calculation of the influence metric 118 is described further with reference to FIG. 4.

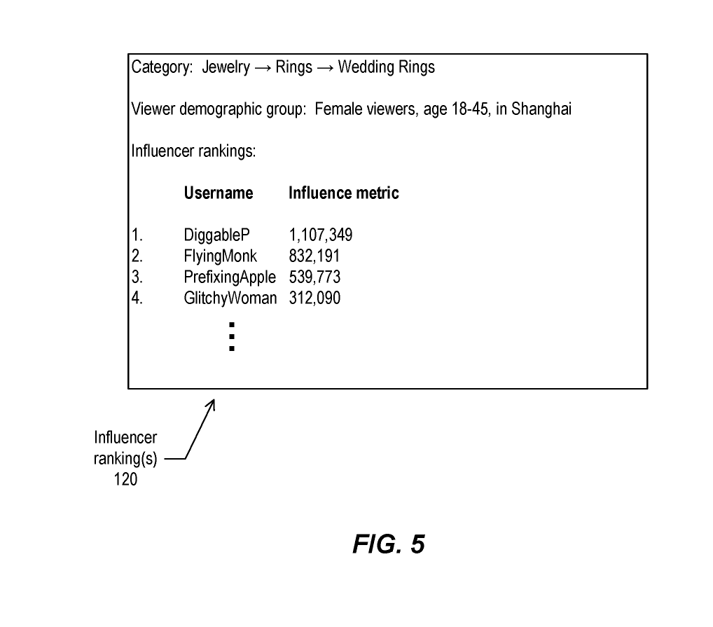

Based on the calculated influence metrics 118 of the publishing user 104 and other publishing user(s), the publishing user 104 may be ranked (208) relative to the other publishing user(s) in a ranked list that is ordered according to the influence metrics 118 of the various users. Such a ranking may be included in the influencer ranking(s) 120 provided to the metrics consumer(s) 122. FIG. 5 depicts an example of influencer ranking(s) 120.

In some implementations, other item metrics may be determined (210) based on analysis of the data retrieved from the network(s) 102. For example, a determination may be made of the number of times particular item(s) 106 are republished or viewed in the network(s) 102. In some implementations, a determination may be made of a number of instances of a particular type of republication for an item 106. For example, the other item metric(s) may indicate a number of times an item 106 is commented on, a number of times an item 106 is shared, a number of times an item 106 is reposted, or a number of times an item 106 is reference in a link that is included in a post. Thus, implementations may measure not only the follower count of a particular publishing user 104 over any number of ripples, but also the extent and manner in which his/her followers are engaged with (e.g., commenting on, reposting) the publishing user's items 106 generally or those items 106 associated with particular categories.

In some implementations, viewer metrics may be determined (212) based on analysis of the data retrieved from the network(s) 102. Such viewer metric(s) may include demographic information as described above, and may indicate the demographic composition of a set of users 108 who are able to view an item 106. For example the viewer metrics may indicate that the published item(s) 106 of a publishing user 104 reach, or are viewable by, a set of users 108 that includes a particular number or proportion of users of a particular gender, age range, location, income range, and so forth.

Information may be provided (214) to metrics consumer(s) 122 such as advertisers, marketers, campaign managers, or others. Such information may include one or more of the influence metric(s) 118, the influencer ranking(s) 120, the other item metric(s), the viewer metric(s), and so forth.

One or both of the influence metric(s) 118 or the influencer ranking(s) 120 may indicate the influence of publishing user(s) 104 in general, without regard to the category of the published item(s) 106. In some implementations, the influence metric(s) 118 and/or the influencer ranking(s) 120 may indicate the influence of publishing user(s) 104 within one or more particular categories at any level in a hierarchy of categories. For example, the influence metric 118 may measure the influence of a publishing user 104 in the area of cars or, more specifically, sports cars. The influence ranking(s) 120 may rank the relative influence of publishing users 104 who publish items 106 related to cars or sports cars.

One or both of the influence metric(s) 118 or the influencer ranking(s) 120 may indicate the influence of publishing user(s) 104 in general, without regard to the demographic characteristics of the potential viewers 108. In some implementations, the influence metric(s) 118 and/or the influencer ranking(s) 120 may indicate the influence of publishing user(s) 104 one users 108 that are associated with a particular set of demographic characteristic(s). For example, the influence metric 118 may measure the influence of a publishing user 104 on users 108 who are male, age 18-35, living in California. The influence ranking(s) 120 may rank the relative influence of publishing users 104 on users 108 of a particular demographic group that exhibits particular demographic characteristic(s). The influence metric(s) 118 and/or the influence ranking(s) 120 may indicate the influence of publishing user(s) 104 with respect to both category and demographic group. In some implementations, the influence metric(s) 118 and/or the influence ranking(s) 120 may indicate the influence of publishing user(s) 104 on users 108 within a particular network (e.g., social network). A particular publishing user 104 may have a first influence metric 118 and/or influence ranking 120 associated with a first network, and that publishing user 104 may have a second, different influence metric 118 and/or influence ranking 120 associated with a second network. For example, a publishing user 104 may be more influential on Weibo™ than on Alibaba™.

FIG. 3 depicts a flow diagram of an example process for determining one or more categories associated with a published item, according to implementations of the present disclosure. Operations of the process may be performed by one or more of the data collection module(s) 112, the analysis module(s) 116, or other software module(s) executing on the analysis computing device(s) 110 or elsewhere.

An item 106 published on a network 102 may be accessed (302). The item 106 may be analyzed, and term(s) present in the item 106 may be compared to a list of terms corresponding to a category, for each of one or more categories. A term may include any amount of data. For example, a term may be a single word or sequence of characters. A term may also include multiple words, such as a phrase or multi-word term. In some implementations, the data in an item 106 may be preprocessed to determine the terms that are present in the item 106. For example, the item 106 may be parsed based on separator characters such as white space (e.g., spaces, new lines, carriage returns), punctuation characters, or other separators. In some examples, where the item 106 includes audio data, the item 106 may be processed using speech-to-text (STT) conversion method(s) to generate text data based on audio input data, prior to calculating the similarity.

A determination may be made (306) whether the calculated similarity meets or exceeds a predetermined threshold level of similarity. If so, the item 106 may be associated (308) with the category. If not, the item 106 may not be associated (310) with the category. The process of FIG. 3 may be repeated for a particular item 106 with respect to any number of categories, and the process may be repeated for any number of items 106. A particular item 106 may be associated with any number of categories. For example, an item 106 may be associated with a category of “restaurants” as well as a more specific category of “Japanese restaurants” and/or “sushi restaurants.”

For each published item 106, the analysis may determine one or more categories and/or keywords for the item 106. The analysis may compare words or multi-word terms in the item 106 to a list of terms that are known to relate to a category, such as a library of terms that have been manually or automatically determined for each category. For example, the use of the word “Tiffany” in the published item 106 may lead to a determination that the item 106 is in the categories “jewelry” and “Tiffany brand jewelry.” Further use of the words “engagement” and “ring” in the published item 106 may indicate other categories of “ring” and “engagement ring.” In some examples, the platform determines a probability that the published item 106 corresponds to a category based on a correspondence (e.g., a statistical similarity measure) between terms in the published item 106 and terms known to correspond to the category. In some implementations, the analysis identifies an exact match between terms in the item 106 and terms in the category-specific list to determine similarity. In some implementations, the analysis may employ semantic analysis based on natural language (NL) processing or other methods to calculate a similarity based on a semantic closeness between the terms of the item 106 and the category-specific list of terms.

A published item 106 may be designated as being within a category if the calculated similarity exceeds a threshold value. In some implementations, the threshold value may be determined by applying a machine learning method based on statistical analysis. For example, implementations may determine a weighting of multiple items in a particular category based on keyword terms present in the items, and use the mean average of the weighting as a threshold or as the basis for the threshold (e.g., threshold=80% of the mean average). In some implementations, a particular published item 106 may be associated with a probability matrix indicating the probabilities that the item 106 corresponds to various categories.

FIG. 4 depicts a flow diagram of an example process for determining an influence metric 118 for a publishing user 104 based on a number of potential viewers 108 of a published item 106, according to implementations of the present disclosure.

An item 106 may be identified (402), the item 106 published by a publishing user 104 on a network 102. In a first iteration (e.g., i=0), a propagation metric may be determined (404) based on the number of followers 108 of the publishing user 104. In some cases, the propagation metric is the number of followers 108. A determination may be made (406) whether any of the followers 108 republished the item 106. If so, the process may iterate (e.g., i=i+1) and determine another propagation metric based on the number of followers 108 of the each of the first set of followers 108 who republished the original item 106. The process may iterate, in this fashion, for any number of iterations to determine the propagation metric for each ripple in the propagation of the item 106 in the network 102. For a particular ripple, if it is determined (406) that no followers republished at that level, the influence metric 118 may be calculated as a sum or other combination of the various propagation metric(s) determined for the various ripples. Accordingly, implementations may be described as traversing a tree structure that corresponds to the propagation of the item 106, where the publishing user 104 is the head node, the republishing followers 108 are branching nodes, and the non-republishing followers 108 are leaf nodes.

Implementations may perform this analysis for one degree of separation (e.g., followers of the publishing user 104), two degrees of separation (e.g., followers of followers), three degrees of separation (e.g., followers of followers of followers), and so forth up to any number of degrees of separation. This algorithm may avoid double-counting users by omitting from the sum those followers at one ripple who are also followers at another ripple, and so forth. The determination of whether a published item 106 is republished may be based on one or more of the following: whether the analysis module(s) 116 detect a particular uniform resource locator (URL) of the published item 106 in the republication; whether the analysis module(s) 116 detect particular terms, or sequences of terms, of the published item 106 in the republication; whether the analysis module(s) 116 detect particular hashtags or other metadata associated with the initial item 106 in the republication; or other criteria.

In some implementations, the platform may determine influence metrics 118 that are related to various categories and/or related to the demographics of the users 108 who were exposed to (e.g., “had eyeballs on”) the published item 106. For example, the platform may determine that a publishing user 104 has an influence metric 118 with respect to published item(s) 104 about sports cars, and a different influence metric 118 with respect to published item(s) 104 about music. In another example, the platform may determine an influence metric 118 indicating the number of users who saw or interacted with the published item, for users having a particular age range, geographic location, gender, and so forth. Accordingly, a particular publishing user 104 may be associated with multiple influence metrics 118, where each influence metric 118 indicates the user's degree of influence for a category, a demographic group, or a combination of category and demographic group. A demographic group may be any combination of one or more demographic factors such as age range, location, gender, financial bracket, health, interests/hobbies/community affiliation, channel (e.g., particular social network 102), etc. Multiple metrics across multiple dimensions may be described as a hypercube or n-dimensional matrix of influence metrics 118 for a publishing user 104.

Demographic information regarding users in network(s) 102 may be gathered from the network profiles or other publicly available information that indicates location, age, gender, interests, spoken language(s), or other information regarding users. Demographic information may also be inferred from published items of the users, using an analysis that is similar to the category determination analysis described above. In some examples, demographic information may be retrieved via an application programming interface (API) exposed by the network(s) 102, such as the Weibo™ API. Implementations may also employ other data sources to determine demographic information, such as census data, retail sales information, and so forth.

FIG. 5 depicts a schematic of an example of influencer ranking(s) 120 based on influence metric(s) 118, according to implementations of the present disclosure. FIG. 5 depicts an example of influencer ranking(s) 120 for a particular category within a hierarchy of categories, in this example the category of “Wedding Rings” which is a subcategory of “Rings” which is a subcategory of “Jewelry.” The influencer ranking(s) 120 rank the influence that various publishing users 104 may have on users in a particular demographic group, in this example users who are female, aged 18-45, living in Shanghai. The influencer ranking(s) 120 includes a ranked list of publishing users 104, ordered according to influence metric 118. For example, the list may include for each publishing user 104 a username of the publishing user 104 on a particular network 102 and the influence metric 118 for the publishing user 104 with respect to the category and/or demographic group. Implementations also support other information, or other arrangements of information, in the influencer ranking(s) 120 generated by the platform and provided to metrics consumer(s) 122.

Information, such as influence metric(s) 118 and/or influencer ranking(s) 120, may be provided to a metrics consumer 122 associated with a company that wants to market or sell a particular product, brand, or service. For example, a company may want to market a particular brand of engagement ring to users aged 18-35 within the greater Shanghai area. The platform may provide a list of influencers (e.g., publishing users 104) ranked according to the influence 118 metric indicating how widely their published items 106 are seen or interacted with by users with those demographic characteristics, for published items 106 related to the category of engagement rings. The company may also be provided with a case study describing results of the influencer previously working with other brands to market products. As another example, a company may wish to market watches to women aged 25-45 in Shanghai, but may wish to market sport watches instead of jewelry-style formal watches. The platform may slice the n-dimensional matrix of influence metrics 118 to identify those influencers most likely to reach a particular subset of female users who are sports-focused or health-focused (e.g., runners, bikers, health club members, etc.).

In some cases, the platform may take time into account, and measure the amount of time a published item 106 takes to propagate outward to other users across any number of ripples. This determination may be based on timestamps of the initial published items 106 and subsequent republications. In some implementations, the platform begins its analysis with a set of publishing users 104 who are known influencers associated with particular categories, as described above. The platform may also begin by analyzing a set of published items 106 for a large collection of publishing users 104 (e.g., randomly selected) instead of starting from a smaller, e.g., curated, set of publishing users 104. For example, the platform may analyze raw data of items 106 published by a set of users related to a new market, new product, new location, or new brand, and determine an initial set of influencers from based on the raw data. In this way, implementations allow advertisers or marketers to go into a new market cold, without needing initial information regarding possible influencers.

In some cases, the platform may reanalyze particular publishing user(s) 104 periodically to determine whether their influence has changed since the last set of influence metrics 118 was calculated. The platform may also identify and flag possible future influencers based in a detected change in influence metrics 118, even if the publishing users' current influence level may not be particularly high. This identification may be based on detecting a rapid change in an influence metric 118, possibly indicating that a publishing user 104 is about to “go hot” or in the process of becoming more popular or influential within a network 102. The determined influence level of a publishing user 104 may also be based on the number of ripples across which the published items 106 of the user 104 propagate. Such ripple propagation information may also be provided to metrics consumers 122.

In some implementations, the platform may identify instances when a particular user X is influential, but only because of one or two particular downstream followers Y who account for the bulk of the follower count of user X. In such examples, the follower(s) Y may be tagged as influencers and user X may be omitted from lists of potential influencers provided to companies, given that the user(s) Y are the actual influencer(s). In this way, the platform may identify users who are influential (e.g., deeper in the ripple) in their own social network, community, or particular niche category, but who may not be otherwise well known as influencers. Such users may not have been in the initial set of users analyzed. Because anyone may be influential in their own sphere of contacts, implementations enable companies to identify and leverage the ways in which average users may be influential.

In some implementations, the platform may determine a saturation rate of a particular user's published items 106 in a target demographic group. For example, the platform may identify a demographic group of users who are enthusiasts of a particular video game ABC, and the platform may determine that influencer Y is able to reach 95% of known users within the particular demographic group when influencer Y posts about videos games generally, posts about a particular genre of video game, or posts about the particular video game ABC.

The platform may also be applied to other uses apart from identifying influencers for marketing or spreading brand awareness. In some cases, the platform may be used to identify a set of possible users for testing a drug, medical procedure, or therapy. For example, the platform may analyze published items 106 to identify users who may suffer from high blood pressure, based on the terms they use, restaurants they visit, beverages they drink (e.g., coffee), emotional indicators (e.g., stress or anger indicators) in their posts, and so forth. Such users may be identified as candidates for testing a blood pressure medicine, or targeted for marketing health insurance products. Moreover, in some examples the platform is used to connect users who may have corresponding needs or interests. For example, user X may be a costumer for a film set in Victorian England, and user Y may be a clothing designer or collector specializing in clothing of that period. The posts of users X and Y may be analyzed to develop profiles for each, and the platform may connect users X and Y based on mutual interests, social needs, business needs, and so forth.

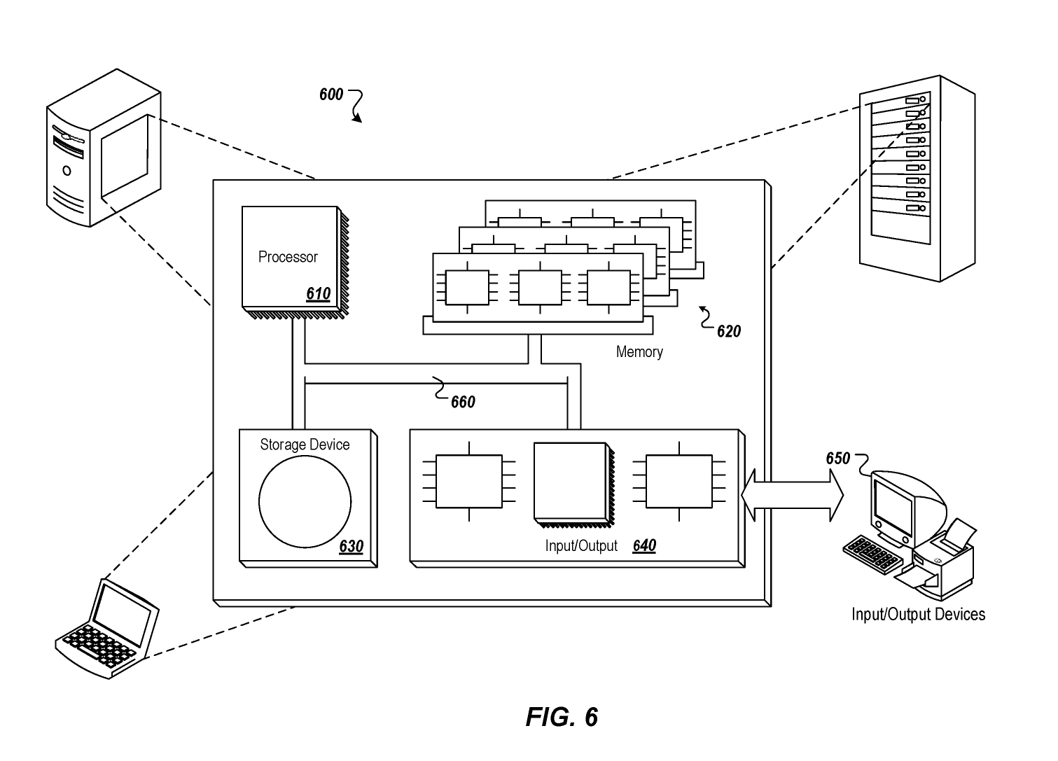

FIG. 6 depicts an example computing system, according to implementations of the present disclosure. The system 600 may be used for any of the operations described with respect to the various implementations discussed herein. For example, the system 600 may be included, at least in part, in the analysis computing device(s) 110 described herein, or in computing device(s) operated by one or more of the user(s) 104, the user(s) 108, or the metrics consumer(s) 122. The system 600 may include one or more processors 610, a memory 620, one or more storage devices 630, and one or more input/output (I/O) devices 650 controllable via one or more I/O interfaces 640. The various components 610, 620, 630, 640, or 650 may be interconnected via at least one system bus 660, which may enable the transfer of data between the various modules and components of the system 600.

The processor(s) 610 may be configured to process instructions for execution within the system 600. The processor(s) 610 may include single-threaded processor(s), multi-threaded processor(s), or both. The processor(s) 610 may be configured to process instructions stored in the memory 620 or on the storage device(s) 630. For example, the processor(s) 610 may execute instructions for the various software module(s) described herein. The processor(s) 610 may include hardware-based processor(s) each including one or more cores. The processor(s) 610 may include general purpose processor(s), special purpose processor(s), or both.

The memory 620 may store information within the system 600. In some implementations, the memory 620 includes one or more computer-readable media. The memory 620 may include any number of volatile memory units, any number of non-volatile memory units, or both volatile and non-volatile memory units. The memory 620 may include read-only memory, random access memory, or both. In some examples, the memory 620 may be employed as active or physical memory by one or more executing software modules.

The storage device(s) 630 may be configured to provide (e.g., persistent) mass storage for the system 600. In some implementations, the storage device(s) 630 may include one or more computer-readable media. For example, the storage device(s) 630 may include a floppy disk device, a hard disk device, an optical disk device, or a tape device. The storage device(s) 630 may include read-only memory, random access memory, or both. The storage device(s) 630 may include one or more of an internal hard drive, an external hard drive, or a removable drive.

One or both of the memory 620 or the storage device(s) 630 may include one or more computer-readable storage media (CRSM). The CRSM may include one or more of an electronic storage medium, a magnetic storage medium, an optical storage medium, a magneto-optical storage medium, a quantum storage medium, a mechanical computer storage medium, and so forth. The CRSM may provide storage of computer-readable instructions describing data structures, processes, applications, programs, other modules, or other data for the operation of the system 600. In some implementations, the CRSM may include a data store that provides storage of computer-readable instructions or other information in a non-transitory format. The CRSM may be incorporated into the system 600 or may be external with respect to the system 600. The CRSM may include read-only memory, random access memory, or both. One or more CRSM suitable for tangibly embodying computer program instructions and data may include any type of non-volatile memory, including but not limited to: semiconductor memory devices, such as EPROM, EEPROM, and flash memory devices; magnetic disks such as internal hard disks and removable disks; magneto-optical disks; and CD-ROM and DVD-ROM disks. In some examples, the processor(s) 610 and the memory 620 may be supplemented by, or incorporated into, one or more application-specific integrated circuits (ASICs).

The system 600 may include one or more I/O devices 650. The I/O device(s) 650 may include one or more input devices such as a keyboard, a mouse, a pen, a game controller, a touch input device, an audio input device (e.g., a microphone), a gestural input device, a haptic input device, an image or video capture device (e.g., a camera), or other devices. In some examples, the I/O device(s) 650 may also include one or more output devices such as a display, LED(s), an audio output device (e.g., a speaker), a printer, a haptic output device, and so forth. The I/O device(s) 650 may be physically incorporated in one or more computing devices of the system 600, or may be external with respect to one or more computing devices of the system 600.

The system 600 may include one or more I/O interfaces 640 to enable components or modules of the system 600 to control, interface with, or otherwise communicate with the I/O device(s) 650. The I/O interface(s) 640 may enable information to be transferred in or out of the system 600, or between components of the system 600, through serial communication, parallel communication, or other types of communication. For example, the I/O interface(s) 640 may comply with a version of the RS-232 standard for serial ports, or with a version of the IEEE 1284 standard for parallel ports. As another example, the I/O interface(s) 640 may be configured to provide a connection over Universal Serial Bus (USB) or Ethernet. In some examples, the I/O interface(s) 640 may be configured to provide a serial connection that is compliant with a version of the IEEE 1394 standard.

The I/O interface(s) 640 may also include one or more network interfaces that enable communications between computing devices in the system 600, or between the system 600 and other network-connected computing systems. The network interface(s) may include one or more network interface controllers (NICs) or other types of transceiver devices configured to send and receive communications over one or more communication networks using any network protocol.

Computing devices of the system 600 may communicate with one another, or with other computing devices, using one or more communication networks. Such communication networks may include public networks such as the internet, private networks such as an institutional or personal intranet, or any combination of private and public networks. The communication networks may include any type of wired or wireless network, including but not limited to local area networks (LANs), wide area networks (WANs), wireless WANs (WWANs), wireless LANs (WLANs), mobile communications networks (e.g., 3G, 4G, Edge, etc.), and so forth. In some implementations, the communications between computing devices may be encrypted or otherwise secured. For example, communications may employ one or more public or private cryptographic keys, ciphers, digital certificates, or other credentials supported by a security protocol, such as any version of the Secure Sockets Layer (SSL) or the Transport Layer Security (TLS) protocol.

The system 600 may include any number of computing devices of any type. The computing device(s) may include, but are not limited to: a personal computer, a smartphone, a tablet computer, a wearable computer, an implanted computer, a mobile gaming device, an electronic book reader, an automotive computer, a desktop computer, a laptop computer, a notebook computer, a game console, a home entertainment device, a network computer, a server computer, a mainframe computer, a distributed computing device (e.g., a cloud computing device), a microcomputer, a system on a chip (SoC), a system in a package (SiP), and so forth. Although examples herein may describe computing device(s) as physical device(s), implementations are not so limited. In some examples, a computing device may include one or more of a virtual computing environment, a hypervisor, an emulation, or a virtual machine executing on one or more physical computing devices. In some examples, two or more computing devices may include a cluster, cloud, farm, or other grouping of multiple devices that coordinate operations to provide load balancing, failover support, parallel processing capabilities, shared storage resources, shared networking capabilities, or other aspects.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a standalone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any appropriate kind of digital computer. Generally, a processor may receive instructions and data from a read only memory or a random access memory or both. Elements of a computer can include a processor for performing instructions and one or more memory devices for storing instructions and data. Generally, a computer may also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

To provide for interaction with a user, implementations may be realized on a computer having a display device, e.g., a CRT (cathode ray tube) or LCD (liquid crystal display) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any appropriate form of sensory feedback, e.g., visual feedback, auditory feedback, or tactile feedback; and input from the user may be received in any appropriate form, including acoustic, speech, or tactile input.

Implementations may be realized in a computing system that includes a back end component, e.g., as a data server, or that includes a middleware component, e.g., an application server, or that includes a front end component, e.g., a client computer having a graphical user interface or a web browser through which a user may interact with an implementation, or any appropriate combination of one or more such back end, middleware, or front end components. The components of the system may be interconnected by any appropriate form or medium of digital data communication, e.g., a communication network. Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some examples be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A computer-implemented method performed by at least one processor, the method comprising:
determining, by the at least one processor, a category of at least one item published by a publishing user on a network;
determining, by the at least one processor, a first propagation metric based on a number of followers of the publishing user on the network;
identifying, by the at least one processor, one or more republications of the at least one item by one or more republishing users on the network;
determining, by the at least one processor, a second propagation metric based on a number of followers of each of the one or more republishing users on the network;
determining, by the at least one processor, an influence metric indicating a level of influence of the publishing user in the category, the influence metric based at least partly on the first propagation metric and the second propagation metric; and
providing, by the at least one processor, a ranked list of the publishing user relative to other users who publish items associated with the category, the ranked list ordered based on the influence metric.

2. The method of claim 1, wherein at least one of the one or more republishing users is a follower of the publishing user.

3. The method of claim 1, wherein:
at least one of the one or more republishing users is a follower of a republishing user; and
the republishing user is a follower of the publishing user.

4. The method of claim 1, further comprising:
determining, by the at least one processor, one or more demographic characteristics of the followers of the publishing user and the followers of the one or more republishing users;
wherein the ranked list ranks the publishing user relative to other users for followers associated with the one or more demographic characteristics.

5. The method of claim 1, wherein determining the category of the at least one item further comprises:
calculating a similarity between terms in the at least one item and a list of terms corresponding to the category; and
associating the item with the category based on the similarity exceeding a threshold level of similarity.

6. The method of claim 1, wherein:
determining the second propagation metric further comprises iteratively counting the number of followers of each republishing user in multiple ripple levels as the at least one item propagates via republication in the network; and
the counting terminates after counting the number of followers in a ripple level that does not include a republishing user.

7. The method of claim 1, wherein the network is a social network.

8. The method of claim 1, wherein the at least one item is published or republished as one or more of a tweet, a post, a share, or a comment.

9. The method of claim 1, wherein the category is included in a hierarchy of categories with different degrees of specificity.

10. The method of claim 1, further comprising:
determining, by the at least one processor, a location of the followers of the publishing user or the followers of the one or more republishing users;
wherein the influence metric further indicates the level of influence of the publishing user in the category toward users in the location.

11. The method of claim 1, wherein the influence metric is further based at least partly on at least one of a number or a proportion of bidirectional connections of the publishing user.

12. The method of claim 1, wherein the influence metric is further based at least partly on a proportion of the number of followers of the publish user to a number of users followed by the publishing user.

13. The method of claim 1, wherein the influence metric is further based at least partly on a change, over time, of a centrality metric for the publishing user.

14. A system, comprising:
at least one processor; and
a memory communicatively coupled to the at least one processor, the memory storing instructions which, when executed by the at least one processor, cause the at least one processor to perform operations comprising:
determining a category of at least one item published by a publishing user on a network;
determining a first propagation metric based on a number of followers of the publishing user on the network;
identifying one or more republications of the at least one item by one or more republishing users on the network;
determining a second propagation metric based on a number of followers of each of the one or more republishing users on the network;
determining an influence metric indicating a level of influence of the publishing user in the category, the influence metric based at least partly on the first propagation metric and the second propagation metric; and
providing a ranked list of the publishing user relative to other users who publish items associated with the category, the ranked list ordered based on the influence metric.

15. The system of claim 14, wherein:
determining the second propagation metric further comprises iteratively counting the number of followers of each republishing user in multiple ripple levels as the at least one item propagates via republication in the network; and
the counting terminates after counting the number of followers in a ripple level that does not include a republishing user.

16. The system of claim 14, wherein the category is included in a hierarchy of categories with different degrees of specificity.

17. The system of claim 14, the operations further comprising:
determining a location of the followers of the publishing user or the followers of the one or more republishing users;
wherein the influence metric further indicates the level of influence of the publishing user in the category toward users in the location.

18. One or more computer-readable media storing instructions which, when executed by at least one processor, cause the at least one processor to perform operations comprising:
determining a category of at least one item published by a publishing user on a network;
determining a first propagation metric based on a number of followers of the publishing user on the network;
identifying one or more republications of the at least one item by one or more republishing users on the network;
determining a second propagation metric based on a number of followers of each of the one or more republishing users on the network;
determining an influence metric indicating a level of influence of the publishing user in the category, the influence metric based at least partly on the first propagation metric and the second propagation metric; and
providing a ranked list of the publishing user relative to other users who publish items associated with the category, the ranked list ordered based on the influence metric.

19. The one or more computer-readable media of claim 18, wherein:
determining the second propagation metric further comprises iteratively counting the number of followers of each republishing user in multiple ripple levels as the at least one item propagates via republication in the network; and
the counting terminates after counting the number of followers in a ripple level that does not include a republishing user.

20. The one or more computer-readable media of claim 18, wherein the category is included in a hierarchy of categories with different degrees of specificity.
